(19) United States
(12) Patent Application Publication
(10) Pub. No.: US 2020/0189532 A1
(43) Pub. Date: Jun. 18, 2020

(54) VEHICLE WASHING APPARATUS AND A METHOD OF CONTROLLING THE SAME

(71) Applicants: HYUNDAI MOTOR COMPANY, Seoul (KR); KIA MOTORS CORPORATION, Seoul (KR)

(72) Inventor: Hyung Jin Kim, Incheon (KR)

(73) Assignees: HYUNDAI MOTOR COMPANY, Seoul (KR); KIA MOTORS CORPORATION, Seoul (KR)

(21) Appl. No.: 16/567,674

(22) Filed: Sep. 11, 2019

(30) Foreign Application Priority Data
Dec. 13, 2018 (KR) 10-2018-0161243

(51) Int. Cl. B60S 3/06; G05D 1/02

(52) U.S. Cl. CPC B60S 3/06; G05D 2201/0203; G05D 1/021

(57) ABSTRACT

A method of controlling a vehicle washing apparatus includes: determining, by a vehicle wash controller, information on an outer appearance of a vehicle based on information acquired from at least one of a data collection unit configured to acquire an image of the vehicle positioned in a vehicle wash region from at least a camera, and a communication unit configured to communicate with a smart device or an external vehicle information server; determining, by the vehicle wash controller, a moving path for washing the vehicle based on the determined information of the outer appearance; and washing the vehicle through a robot unit including at least one vehicle washing device and a moving unit configured to move or fix a position of the robot unit in the vehicle wash region according to control of the vehicle wash controller.

This application claims priority to and the benefit of Korean Patent Application No. 10-2018-0161243, filed on Dec. 13, 2018, which is hereby incorporated by reference as if fully set forth herein.

### BACKGROUND

### Field of the Disclosure

The present disclosure relates to a vehicle washing apparatus and a method of controlling the same, and more particularly to a washing apparatus and a method for effectively washing a vehicle by acquiring information on the outer appearance of the vehicle.

### Discussion of the Related Art

Vehicles have become a very important part of our lives. Accordingly, many drivers spend time and money maintaining their vehicles. Washing a vehicle is an important part of such maintenance. Washing a vehicle is one of the necessary maintenance activities required to ensure a normal operation of various sensors in new and redesigned vehicles that have various electronic devices installed therein. Thus, washing a vehicle may be more important and may involve more than simply maintaining a clean outer appearance of the vehicle.

In general, an automatic car wash or a manual car wash is used to wash vehicles. Most automatic car washing apparatuses are tunnel type car washing apparatuses, and thus require relatively large facilities and spaces. On the other hand, a manual car wash or self-car wash requires a relatively small space. However, in this case, a user needs to directly use a high-pressure hose, a form gun, a blower, and the like.

For a more convenient manual car wash, Korean Patent Publication No. 10-2012-0001351 proposes an automatic car wash. According to Publication No. 10-2012-0001351, a car washing apparatus automatically washes a vehicle while linearly moving above the vehicle. However, most vehicle bodies are designed with curved surfaces rather than flat surfaces. Additionally, according to recent trends in vehicle design, vehicle bodies increasingly have curved and bent body portions. Therefore, few vehicular parts or vehicle types are capable of being washed via simple linear movement.

According to the foregoing application, it is not possible to separately determine whether a nonferrous vehicle component such as glass is present or to determine the position thereof. Movement of the car washing apparatus is also limited because the car washing apparatus is moved based on a solenoid.

In addition, the vehicle washing apparatus is independently operated. Thus, there is a problem in that limitations are imposed by the weight of materials that must be conveyed thereby, such as a water tank or detergent.

### SUMMARY

Accordingly, the present disclosure is directed to a vehicle washing apparatus and a method of controlling the same that substantially obviates one or more problems due to limitations and disadvantages of the related art.

An object of the present disclosure is to provide a vehicle washing apparatus and a method of controlling the same for a more convenient vehicle wash.

In particular, an object of the present is to provide a vehicle washing apparatus and a method of controlling the same for effectively washing a vehicle by acquiring information on the outer appearance of the vehicle.

Additional advantages, objects, and features of the disclosure are set forth in part in the description, which follows, and in part should become apparent to those having ordinary skill in the art upon examination of the following or may be learned from practice of the disclosed embodiments. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of controlling a vehicle washing apparatus is disclosed. The method includes determining, by a vehicle controller, information on an outer appearance of a vehicle based on information acquired from at least one of a data collection unit configured to acquire an image of the vehicle positioned in a vehicle wash region from at least a camera, and a communication unit configured to communicate with a smart device or an external vehicle information server. The method further includes determining, by the vehicle wash controller, a moving path for washing the vehicle based on the determined information of the outer appearance. The method also includes washing the vehicle through a robot unit including at least one vehicle washing device and a moving unit configured to move or fix a position of the robot unit in the vehicle wash region according to control of the vehicle wash controller. The moving path includes at least one of an autonomous moving path of the robot unit or a guided moving path of the robot unit through the moving unit.

In another aspect of the present disclosure, a vehicle washing apparatus includes: a vehicle wash control device including a data collection unit configured to acquire an image of the vehicle positioned in a vehicle wash region from at least a camera; a communication unit configured to communicate with a smart device or an external vehicle information server; and a vehicle wash controller configured to determine information on an outer appearance of the vehicle based on information acquired from at least one of the data collection unit and the communication unit and to determine a moving path for washing the vehicle based on the determined information of the outer appearance. The vehicle washing apparatus further includes a robot unit controlled by the vehicle wash controller. The robot unit includes at least one vehicle washing device. The vehicle washing apparatus also includes a moving unit controlled by the vehicle wash controller and configured to move or fix a position of the robot unit within the vehicle wash region. The moving path includes at least one of an autonomous moving path of the robot unit or a guided moving path of the robot unit through the moving unit.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram showing an example of the configuration of a vehicle washing apparatus according to an embodiment of the present disclosure;

FIG. 2A is a perspective view showing an example of the configuration of a robot unit according to an embodiment of the present disclosure;

FIG. 2B is a diagram showing an example of a bottom surface of a robot unit according to an embodiment of the present disclosure;

FIG. 3 is a flowchart showing an example of a vehicle wash control procedure according to an embodiment of the present disclosure;

FIG. 4 is a flowchart showing an example of a procedure of changing a vehicle wash procedure based on user control according to an embodiment of the present disclosure;

FIGS. 5A and 5B are diagrams showing an example of an input form of vehicle data information according to an embodiment of the present disclosure;

FIGS. 6A-6C are diagrams showing an example of a user interface of a display unit according to an embodiment of the present disclosure;

FIGS. 7A and 7B are diagrams showing an example of a changed form of a vehicle wash mode according to an embodiment of the present disclosure;

FIGS. 8A and 8B are diagrams showing an example of a changed form of a vehicle washing position according to an embodiment of the present.

### DETAILED DESCRIPTION OF THE DISCLOSURE

Embodiments of the present disclosure are described in detail so that those of ordinary skill in the art may easily implement the disclosure with reference to the accompanying drawings. However, the present disclosure may be implemented in various different forms and is not limited to these embodiments. To clearly describe the present embodiments, some parts not related to the description have been omitted in the drawings. Like reference numerals in the specification and drawings denote like elements.

In addition, when a certain part “includes” a certain component, this indicates that the part may further include another component instead of excluding another component unless there is no different disclosure. The same reference numbers are used throughout the drawings and the specification to refer to the same parts.

An embodiment of the present disclosure proposes a robot unit that washes a vehicle while moving along an outer part of the vehicle depending on an external shape of the vehicle. The external shape of the vehicle is acquired using various methods. In this case, the robot unit may autonomously move or may be moved by a moving unit.

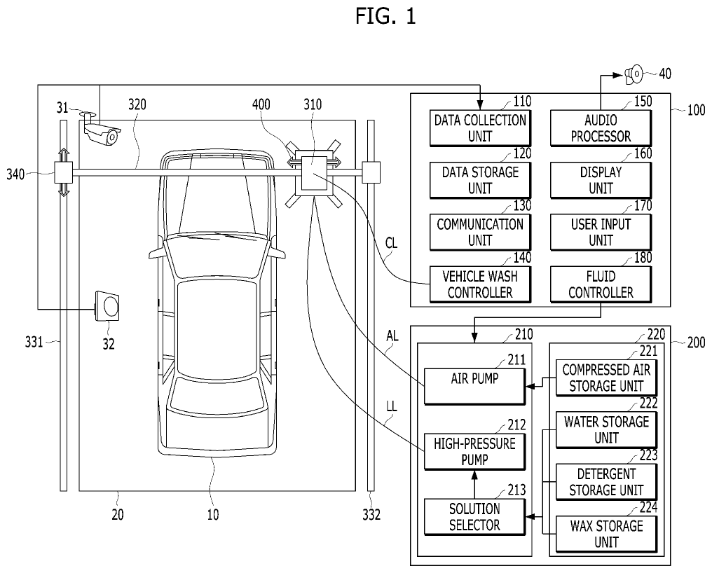

The configuration of a vehicle washing apparatus applicable to various embodiments is described below with reference to FIG. 1. FIG. 1 is a diagram showing an example of the configuration of a vehicle washing apparatus according to an embodiment of the present disclosure.

Referring to FIG. 1, the vehicle washing apparatus according to an embodiment may include a vehicle wash control device 100, a fluid management unit 200, moving units 310, 320, 331, 332, and 340, a robot unit 400, and other external devices 31, 32, and 40.

The vehicle wash control device 100 may include a data collection unit 110, a data storage unit 120, a communication unit 130, a vehicle wash controller 140, an audio processor 150, a display unit 160, a user input unit 170, and a fluid controller 180.

The data collection unit 110 may determine from a camera 31 whether a vehicle 10 enters a vehicle wash region of a vehicle 10 as a wash target. The camera 31 may capture an image of at least the vehicle wash region 20. The data collection unit 110 may acquire an image for determination of the data and the outer appearance (e.g., additional accessories) of the vehicle. The data collection unit 110 may further acquire position information of the vehicle 10 in the vehicle wash region 20 from a sensor 32. In this case, two or more cameras 31 may be disposed to have different photographing ranges.

The data storage unit 120 may store vehicle data information that is acquired through the communication unit 130. The data storage unit 120 may also perform a function of storing various pieces of input/output information of the vehicle wash control device 100, the operating system, and an application program for driving the vehicle wash control device 100.

The communication unit 130 may include a modem based on at least one communication program for communication with an external object. For example, the communication unit 130 may include an Internet modem for communication with a vehicle information server, to be described below, a wireless communication (Bluetooth, WiFi, near field communication (NFC), or the like) modem for communication with a device (e.g., a smartphone) owned by a user, a cellular (3G/4G/5G) modem, or the like. Needless to say, in some embodiments, the communication unit 130 may also perform wired communication using a universal serial bus (USB) or the like.

The vehicle information server may receive an image of the outer appearance of a vehicle, which is acquired by the data collection unit 110 through the camera 31, through the communication unit 130. The vehicle information server may analyze the image and may return information on vehicle data (type) related to at least the outer appearance of the vehicle to the communication unit 130. For example, the information on the vehicle data may basically include information on the entire width, total length, and total height of the vehicle and may include 3D modeling information of the outer appearance thereof. The vehicle information server may also share pre-registered vehicle data (information) with only registered customers through a smartphone using a vehicle number, registered phone information, or the like during analysis of the vehicle data. In this case, since an application for washing a vehicle is used in a smartphone, vehicle information of an owner may be provided to the communication unit 130.

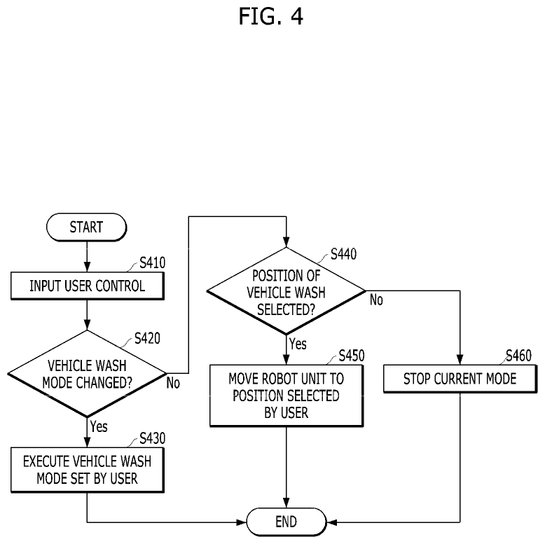

The vehicle wash controller 140 may acquire information on the outer appearance of the vehicle based on data collected through at least one of the data collection unit 110, the data storage unit 120, the communication unit 130, and the user input unit 170. The vehicle wash controller 140 may calculate a moving path of the robot unit 400 based on the acquired information. In this case, the moving path of the robot unit 400 may conceptually include an autonomous moving path of the robot unit 400 and a guided moving path of the robot unit 400 through the moving units 310, 320, 331, 332, and 340. The vehicle wash controller 140 may control the robot unit 400 and moving devices 310 and 340 of the moving unit to wash a vehicle according to a preset vehicle wash mode (e.g., water wash-foam wash-waxing-dry) while the robot unit is moved along the calculated moving path. When a user controls the robot unit 400, the vehicle wash controller 140 may also control a procedure of changing vehicle wash processes according to user selection, which is described below in more detail with reference to FIG. 4. The vehicle wash controller 140 may make a request to the robot unit 400 for the supply of required fluid as the vehicle wash mode is executed. The vehicle wash controller 140 may transmit a control signal to the moving device 310 of the moving unit and the robot unit 400 through a control line CL. A signal line of the control line CL, for control of the robot unit 400, may be branched from the moving device 310 and may be connected to the robot unit 400 through a connection unit 350, which is described below. Needless to say, in some embodiments, the vehicle wash controller 140 may be wirelessly connected to the robot unit 400 or the moving device 310 through the communication unit 130.

The audio processor 150 may output sound such as a warning sound or guidance sound through a speaker 40.

The display unit 160 may display various pieces of information related to the operation of the vehicle washing apparatus. For example, the display unit 160 may display a user interface for control of verification or changing of vehicle information, washed part/mode changing, vehicle wash start/stop, or the like. When the display unit 160 is embodied as a touchscreen, the display unit 160 may perform a partial function of the user input unit 170.

The user input unit 170 may include an input device such as a key button, a dial, a switch, or a touch pad for receiving a command from a user.

The fluid controller 180 may control the operation of the fluid management unit 200 in response to a request from the vehicle wash controller 140.

The fluid management unit 200 may include a fluid supply unit 210 and a fluid storage unit 220. The fluid supply unit 210 may include an air pump 211, a high-pressure pump 212, and a solution selector 213. The fluid storage unit 220 may include a compressed air storage unit 221, a water storage unit 222, a detergent storage unit 223, and a wax storage unit 224.

At least one of the water storage unit 222, the detergent storage unit 223, and the wax storage unit 224 may have therein a pump for supplying a solution stored therein to the solution selector.

The solution selector 213 may perform a solution switching function of supplying a solution corresponding to the vehicle wash mode including water, detergent, and wax to the high-pressure pump 212.

The high-pressure pump 212 may supply the corresponding solution to the robot unit 400 through a liquid line LL.

The air pump 211 may supply air stored in the compressed air storage unit 221 to the robot unit 400 through an air line AL. In some embodiments, the compressed air storage unit 221 may be omitted, and the air pump 211 may directly supply surrounding air to the robot unit 400.

Due to this configuration of the fluid management unit 200, the robot unit 400 may receive required fluid among water, detergent, wax, and air, according to the vehicle wash mode.

Hereinafter, the moving unit is described. The moving unit may include a robot holder 310 connected to the robot unit 400 through the connection unit 350 to be described below, a first rail 320 that provides a path for moving the robot holder 310 in a first direction (the horizontal direction in FIG. 1), rail moving devices 340 disposed at opposite ends of the first rail 320, and second rails 331 and 332 that provide a path for moving the rail moving devices 340 in a second direction (the vertical direction in FIG. 1). In this case, the length of each of the first rail 320 and the second rails 331 and 332 may be determined to correspond to the vehicle wash region 20. A height thereof (e.g., 2m (about 6.56 feet) or greater) may be higher than the total height of a general vehicle. Due to this configuration of the moving unit, the position of the robot unit 400 may be changed as desired within the vehicle wash region 20. Needless to say, the configuration of the moving unit is merely an example. In some embodiments, the moving unit may be configured in the form of a robot arm or the like and may not be limited to a particular type as long as the moving unit enables the robot unit 400 to move as desired within the vehicle wash region 20.

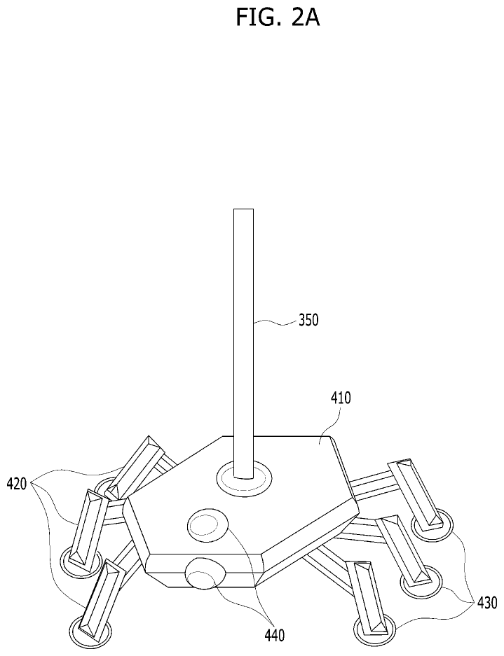

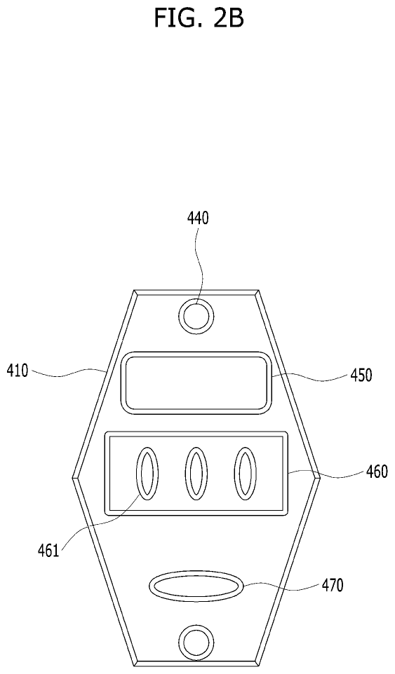

Hereinafter, the configuration of the robot unit 400 is described with reference to FIGS. 2A and 2B. In FIGS. 2A and 2B, the lines CL, LL, and AL are not omitted.

FIG. 2A is a perspective view showing an example of the configuration of a robot unit according to an embodiment of the present disclosure.

Referring to FIG. 2A, the robot unit 400 may include a body 410, a plurality of legs 420, ground parts 430 that are disposed at respective ends of the plurality of legs 420, and one or more cameras 440.

The body 410 may be connected to the robot holder 310 of the moving unit through the connection unit 350, and may be connected to a signal line of the control line CL, for control of the robot unit 400, through the connection unit 350. The body 410 may have therein a processor for control of the overall operation of the robot unit 400 including the remaining components such as the legs 420, the ground parts 430, and the cameras 440 according to a control signal from the vehicle wash controller 140, and an actuator for moving each of the legs 420.

The legs 420 may enable autonomous movement of the robot unit 400, may ensure an interval between the vehicle body and the body 410, and may fix and support the robot unit 400 on the vehicle body. Each of the legs 420 may include one or more joints in order to ensure a sufficient number of degrees of freedom.

The ground parts 430 may be disposed at the respective legs 420 or may be disposed at ends of at least some of the legs 420. The ground parts 430 may include an electromagnet that is controlled in an activated or inactivated state in order to fix the vehicle body. The external surface of the ground parts 430 may be finished with a soft finishing material for preventing a painted surface of the vehicle body from being damaged in the case of contact with the painted surface.

The cameras 440 may be disposed to acquire at least an image of a vehicle part that is currently being washed.

Although only one connection unit 350 is illustrated, two or more connection units may be used and may be configured in the form of a rod or a wire in some configurations. In the case of the rod, the connection unit 350 may include one or more controllable joints. For example, the distance between the robot unit 400 and the robot holder 310, i.e., a vertical distance between the robot unit 400 and the vehicle 10, may be adjusted via joint driving in the case in which the connection unit 350 includes joints or wire winding in the case in which the connection unit 350 is configured in the form of a wire.

FIG. 2B is a diagram showing an example of a bottom surface of a robot unit according to an embodiment of the present disclosure.

Referring to FIG. 2B, the robot unit 400 may include a vehicle washing device. The vehicle washing device may include a roller 450, a solution nozzle module 460, and an air nozzle 470. The cameras 440, the roller 450, the solution nozzle module 460, and the air nozzle 470 may be disposed on the bottom surface of the body 410 of the robot unit 400.

The roller 450 may be used for foam washing and may remove pollutants from the surface of a vehicle body via rotatory motion in a contact manner. To this end, the surface of the roller 450 may be formed of a soft spongy body or fiber aggregate.

The solution nozzle module 460 may include nozzles 461 that correspond to water, detergent, and wax, respectively, and may spray corresponding liquids through the respective nozzles. In this case, each nozzle may include an actuator for changing a spray direction. In some embodiments, a nozzle for spraying detergent may be built into the roller 450.

The air nozzle 470 may blow air for moisture removal and drying.

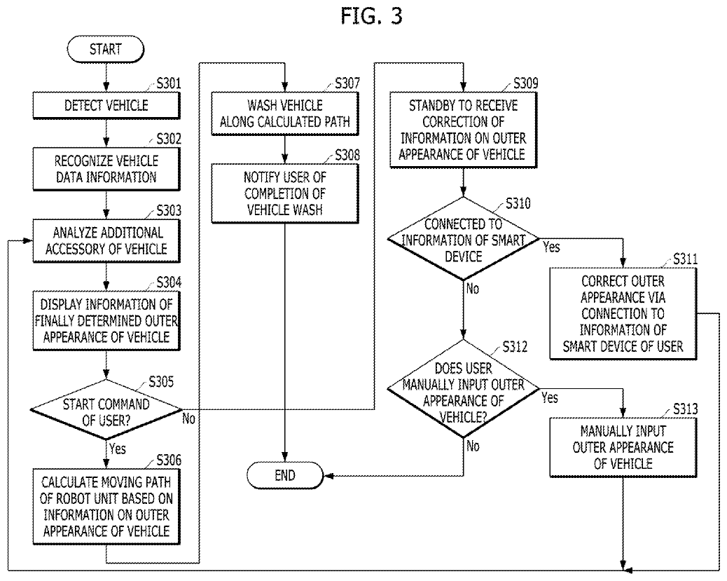

Hereinafter, a vehicle wash control procedure is described with reference to FIG. 3 based on the aforementioned detailed configuration of the vehicle washing apparatus.

FIG. 3 is a flowchart showing an example of a vehicle wash control procedure according to an embodiment of the present disclosure.

Referring to FIG. 3, whether the vehicle 10 is disposed in the vehicle wash region 20 may be detected based on information acquired through at least one of the camera 31 and the sensor 32 (S301).

When the vehicle is detected, vehicle data information may be acquired via image-based vehicle type recognition using an image captured by the camera 31, a connection to a vehicle information server through the communication unit 130, or a manual input using the input unit 170 (S302).

When information on the basic outer appearance of the vehicle is acquired through the vehicle data information, the shape of an additional accessory of a vehicle may be analyzed (S303). This process may also be performed via image-based accessory recognition using an image captured by the camera 31, a connection to the vehicle information server through the communication unit 130, or a manual input using the input unit 170. The additional accessory may correspond to a spoiler, a loopback, an antenna, or the like. The additional accessory is not limited to any particular type, as long as the additional accessory additionally changes the outer appearance of a vehicle compared to the state when the vehicle was released.

When information on the outer appearance based on the additional accessory as well as the information on the basic outer appearance is acquired, information of the finally determined outer appearance of the vehicle may be output through the display unit 160 (S304). Needless to say, the information of the outer appearance of the vehicle may also be displayed through a smart device carried by a vehicle owner.

Then, when a user (e.g., a vehicle owner or a vehicle washing apparatus operator) inputs a start command (S305), the vehicle wash controller 140 may calculate a moving path of the robot unit 400 based on the finally determined outer appearance of the vehicle (S306). In this case, as described above, the moving path may conceptually include an autonomous moving path using the legs 420 of the robot unit 400 and a guided moving path of the robot holder 310. Calculation of the moving path may be determined according to a preset algorithm and the present disclosure is not limited to any algorithm configuration. For example, calculation of the moving path may be configured based on the shortest moving path, may be configured in a downward direction from a roof, or may be configured in a direction toward a rear surface from a front surface of the vehicle.

When calculation of the moving path is completed, vehicle washing may be performed along the calculated moving path (S307). When vehicle washing is completed, a notification indicating completion of vehicle washing may be output through at least one of the display unit 160, the speaker 40, and a smart device of a vehicle owner (S308).

When the user does not consent to perform washing based on the information of the finally determined outer appearance (NO of S305), the vehicle wash controller 140 may enter a standby state in which it is on standby to receive correction of the information of the outer appearance (S309).

Accordingly, when the vehicle owner performs smart device information connection (YES of S310), the information of the outer appearance may be additionally corrected via a smart device information connection of the user (S311). In addition, when the user manually inputs correction information of the outer appearance of the vehicle (YES of S312), the information of the outer appearance may be additionally corrected based on the manually input information on the outer appearance (S313).

When vehicle washing is performed (S307), a vehicle wash procedure may be changed according to control by the user, which is described below with reference to FIG. 4.

FIG. 4 is a flowchart showing an example of a procedure of changing a vehicle wash procedure based on user control according to an embodiment of the present disclosure.

Referring to FIG. 4, a user may input a user control command through the user input unit 170 or a coupled smart device (S410).

When the user control command corresponds to a change in a vehicle wash mode (YES of S420), a vehicle wash mode set by the user may be immediately executed (S430).

On the other hand, when the user control command does not correspond to a change in a vehicle wash mode (NO of S420), and when the user control command corresponds to a position selection of vehicle washing (YES of S440), the robot unit 400 may be moved to the position selected by the user and vehicle washing may be performed (450).

When the user control command does not correspond to a change in a vehicle wash mode (NO of S420) and when the user control command does not correspond to a position change of vehicle washing (NO of S440), the currently executed vehicle wash mode may be stopped (S460).

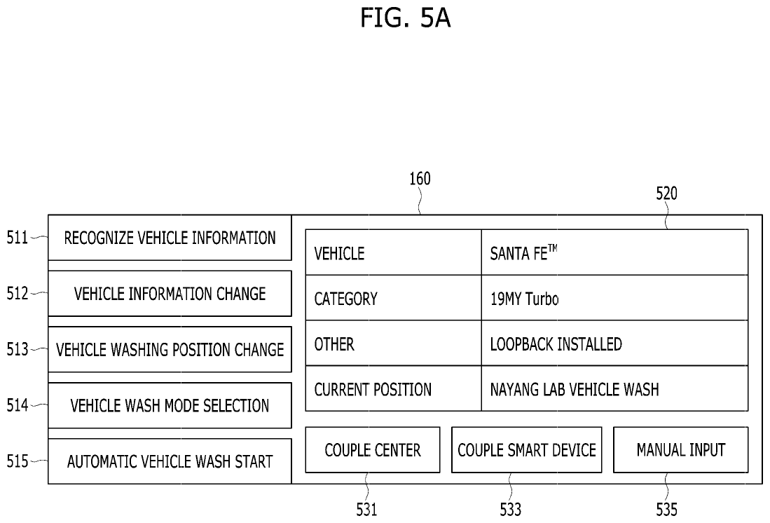

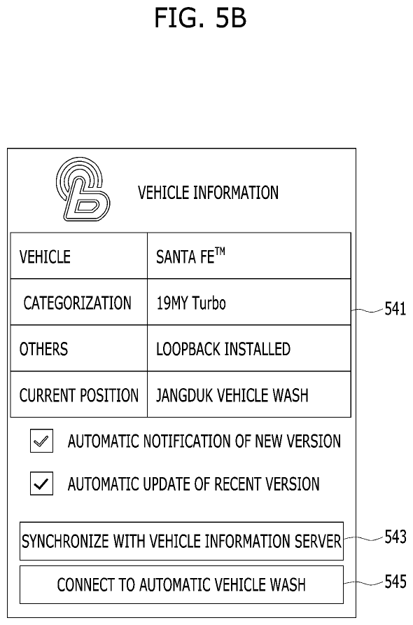

Hereinafter, a detailed configuration of a user interface to be output through the display unit 160 or a smartphone of a user is described below with reference to FIGS. 5-8.

FIGS. 5A and 5B are diagrams showing an example of an input form of vehicle data information according to an embodiment of the present disclosure.

Referring to FIG. 5A, main menus 511, 512, 513, 514, and 515 for selection of a main function of a vehicle washing apparatus may be displayed on a left part of the display unit 160. Currently acquired vehicle data information 520 may be displayed on the upper-right part of the display unit 160 as the vehicle information menu 511 is recognized and selected among the main menus. Menu buttons 531, 533, and 535 for selection of a device for acquisition of vehicle data information may be selectively displayed on a lower-right part of the display unit 160. The user interface may be output in operation S302 of FIG. 3.

As shown in FIG. 5B, an execution image of an application for coupling the vehicle washing apparatus to the smart device of the user may be displayed. In the execution image, a button 543 for synchronization with a vehicle information server and a button 545 for connection to the communication unit 130 of the vehicle washing apparatus may be disposed with vehicle data information 541 stored in the smart device.

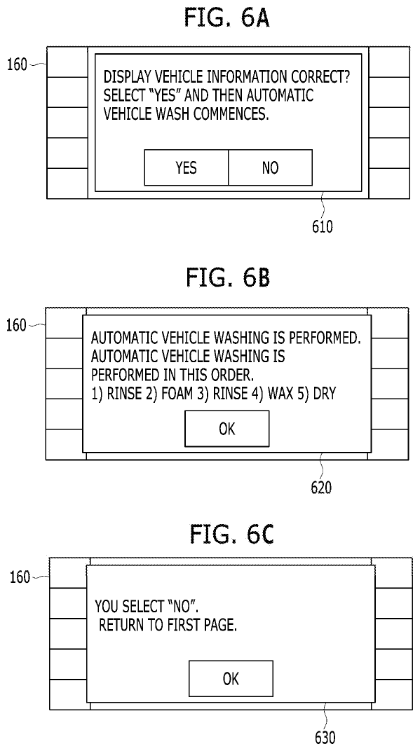

FIGS. 6A and 6B are diagrams showing an example of a user interface of a display unit according to an embodiment of the present disclosure.

Referring to FIG. 6A, as a user selects the menu 515 to start automatic vehicle washing, a pop-up window 610 for receiving a user start command corresponding to operation S305 of FIG. 3 may be output through the display unit 160. In this embodiment, when the user selects “YES”, a pop-up window 620 for guiding the sequence of automatic vehicle washing may be displayed as shown in FIG. 6B. On the other hand, when the user selects “NO”, a vehicle wash cancellation notification 630 may be displayed in FIG. 6A. Needless to say, this is an example, and when “NO” is selected, a menu for correction of information on the outer appearance may also be output as described above with reference to FIG. 3.

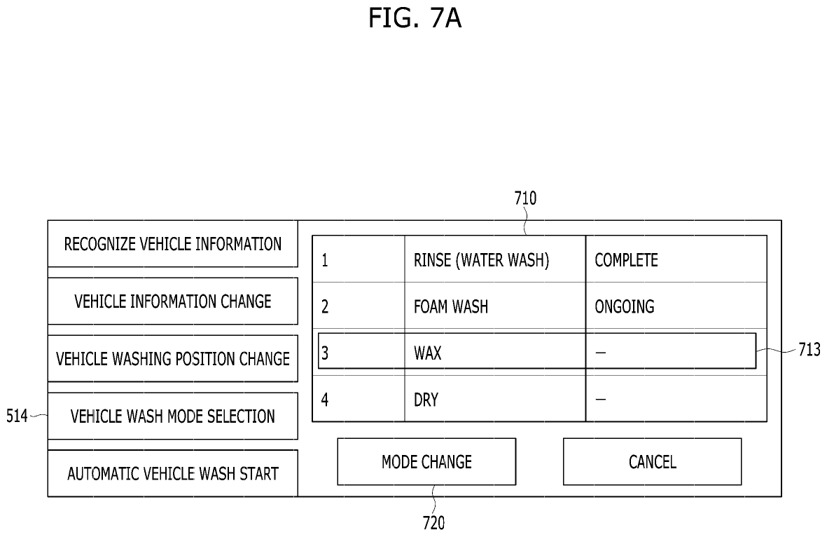

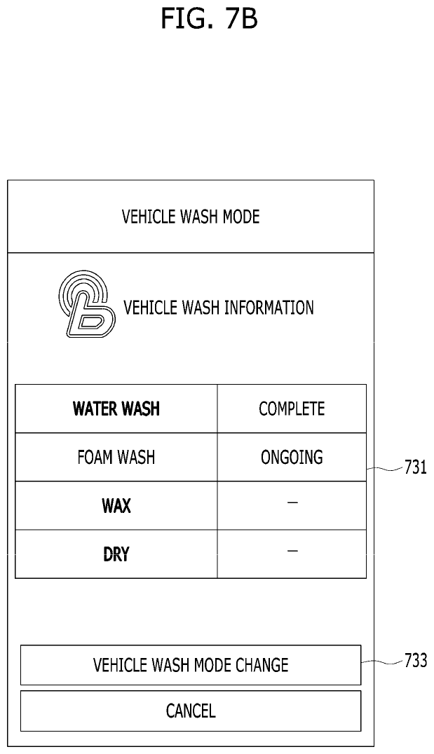

FIGS. 7A and 7B are diagrams showing an example of a changed form of a vehicle wash mode according to an embodiment of the present disclosure. FIGS. 7A and 7B may correspond to a user interface for the vehicle wash mode change S420 described above with reference to FIG. 4.

Referring to FIG. 7A, when the user selects a vehicle wash mode selection menu 514 from the main menu, the progress 710 of each vehicle wash mode may be displayed on the right part of the display unit 160. In this embodiment, when the user wants to change the current mode to a wax mode without foam washing, the user may change the current mode to the wax mode by selecting a displayed region 713 corresponding to the wax mode and then manipulating a mode change button 720.

Similarly, as shown in FIG. 7B, the user may also change the vehicle wash mode through a smart device coupled through the communication unit 130. In detail, the progress 731 of each vehicle wash mode may also be displayed on the smart device. The user may change the vehicle wash mode by selecting a desired vehicle wash mode and then manipulating a wash mode change button 733.

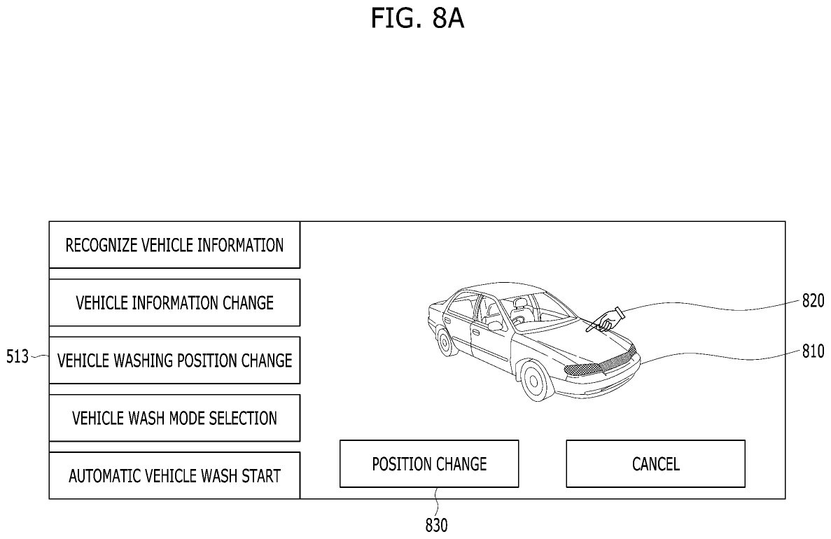

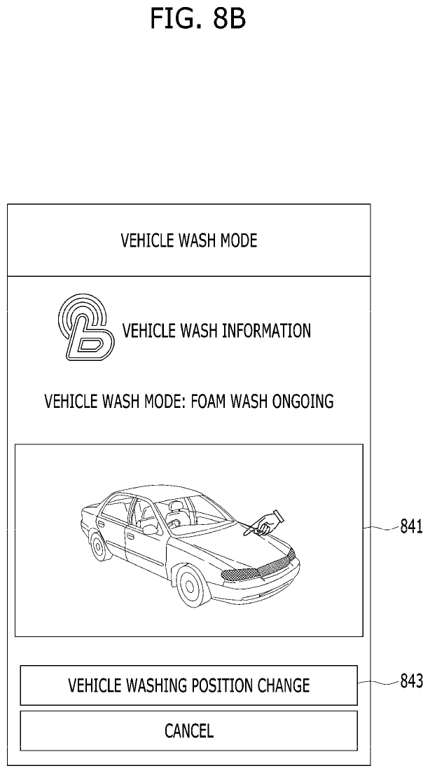

FIGS. 8A and 8B are diagrams showing an example of a changed form of a vehicle washing position according to an embodiment of the present disclosure.

Referring to FIG. 8A, when a user selects a vehicle washing position change menu 513 from a main menu, a vehicle image 810 may be displayed on the right part of the display unit 160. In this embodiment, when the user selects a part 820 to be immediately washed and manipulates a position change button 830, vehicle washing of the corresponding part may be immediately started.

Similarly, as shown in FIG. 8B, the user may also change a position at which vehicle washing is performed through a smart device coupled through the communication unit 130. In detail, a vehicle image 841 may also be displayed on the smart device. The user may change the part of the vehicle that is being washed by selecting a desired washing position and then manipulating a vehicle wash position change button 843.

Table 1 below shows a comparison between the aforementioned function of the vehicle washing apparatus and a general vehicle wash procedure.

TABLE 1

| | Procedure | | |
|---|---|---|---|
| | categori- | Device | |
| Operation | zation | (operation) | Processing module |
| 1. Water | 1-1. Manual | Vehicle | High-pressure motor (water) |
| spray | vehicle | wash gun | |
| | wash | | |
| 1. Water | 1-2. Robot | Vehicle | Moving unit + robot unit |
| spray | vehicle | wash robot | (water nozzle) + high- |
| | wash | | pressure pump (water) |
| 2. Lather | 2-1. Manual | Mop for | High-pressure motor (water) + |
| | vehicle | foam | detergent pump + detergent |
| | wash | | container |
| 2. Lather | 2-2. Robot | Vehicle | Moving unit + robot unit |
| | vehicle | wash robot | (roller) + high-pressure |
| | wash | | pump (detergent) |
| 3. Rinse | 3-1. Manual | Vehicle | High-pressure motor (water) |
| | vehicle | wash gun | |
| | wash | | |
| 3. Rinse | 3-2. Robot | Vehicle | Moving unit + robot unit |
| | vehicle | wash robot | (water nozzle) + high- |
| | wash | | pressure pump (water) |
| 4. Wax | 4-1. Manual | Vehicle | High-pressure motor (water) + |
| | vehicle | wash gun | pump for wax + wax tank |
| | wash | | |
| 4. Wax | 4-2. Robot | Vehicle | Moving unit + robot unit |
| | vehicle | wash robot | (wax nozzle) + high- |
| | wash | | pressure pump (wax) |
| 5. Dry | 5-1. Manual | Mopping | ※ In the case of tunnel |
| | vehicle | action of | type automatic car wash, water |
| | wash | user | is removed using air nozzle |
| 5. Dry | 5-2. Robot | vehicle | moving unit + robot unit |
| | vehicle | wash robot | (air nozzle) |
| | wash | | |

The aforementioned vehicle washing apparatus according to various embodiments may acquire information on the outer appearance of a vehicle using various methods. The vehicle washing apparatus may further determine a moving method and a moved position of a robot unit based on the acquired information on the outer appearance of the vehicle. The vehicle washing apparatus may also wash the vehicle while recognizing a wash state in real time by a camera.

Accordingly, merely by securing a space larger than a vehicle to be washed, the robot unit may be freely moved through the moving unit in order to perform vehicle washing. Thus, a few spatial restrictions are imposed. In addition, information on the outer appearance of a vehicle may be acquired. Thus, the present disclosure is not limited to the type of vehicle.

In the vehicle-washing apparatus configured as described above related to at least one embodiment of the present disclosure, movement of the robot unit may be determined depending on the outwardly apparent shape of the vehicle. The exterior shape of the vehicle may be acquired using various methods, and accordingly the vehicle may be effectively washed.

A vehicle wash robot unit may be capable of being autonomously moved. The vehicle wash robot unit may be capable of maintaining the position thereof irrespective of the shape or material of a washed part by a robot moving unit for maintaining or changing the position of the vehicle wash robot unit with respect to a vehicle. The vehicle wash robot unit may also be capable of being rapidly moved to another washed part.

In addition, the vehicle wash robot unit does not contain water or detergent therein. Thus, the vehicle wash robot is not limited by the weight of water, detergent, or the like loaded therein.

It will be appreciated by persons having ordinary skill in the art that the effects that could be achieved with the present disclosure are not limited to what has been particularly described hereinabove. Other advantages of the present disclosure will be more clearly understood from the detailed description.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid-state drive (SSD), a silicon disc drive (SDD), read-only memory (ROM), random-access memory (RAM), CD-ROM, magnetic tapes, floppy disks, optical data storage devices, and the like.

It will be apparent to those having ordinary skill in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A method of controlling a vehicle washing apparatus, the method comprising:
determining, by a vehicle wash controller, information on an outer appearance of a vehicle based on information acquired from at least one of a data collection unit configured to acquire an image of the vehicle, which is positioned in a vehicle wash region, from at least a camera, or a communication unit configured to communicate with a smart device or an external vehicle information server;
determining, by the vehicle wash controller, a moving path for washing the vehicle based on the determined information of the outer appearance; and
washing the vehicle through a robot unit including at least one vehicle washing device and a moving unit configured to move or fix a position of the robot unit in the vehicle wash region according to control of the vehicle wash controller,
wherein the moving path includes at least one of an autonomous moving path of the robot unit or a guided moving path of the robot unit through the moving unit.

2. The method of claim 1, wherein the vehicle washing device includes at least one of a roller, at least one solution nozzle, and an air nozzle.

3. The method of claim 2, further comprising:
receiving, by the robot unit, a solution corresponding to the at least one solution nozzle from a fluid management unit; and
receiving, by the robot unit, air from the fluid management unit through the air nozzle,
wherein the solution includes at least water, detergent, or wax.

4. The method of claim 1, wherein the robot unit includes a plurality of legs for performing autonomous movement.

5. The method of claim 4, wherein an electromagnet for selectively generating magnetism is disposed at an end of each of the plurality of legs.

6. The method of claim 1, wherein the determining the information on the outer appearance includes:
by the vehicle wash controller, transmitting the image to the external vehicle information server, making a request for data information related to the outer appearance of the vehicle, and receiving the data information through the communication unit; or
receiving the data information from the smart device.

7. The method of claim 6, wherein the determining the information on the outer appearance includes determining the information on the outer appearance of the vehicle in consideration of an additional accessory of the vehicle together with the data information.

8. The method of claim 1, wherein the moving unit is moved along two axes that cross each other above the vehicle and includes a robot holder connected to the robot unit through a connection unit.

9. The method of claim 8, wherein a vertical distance between the robot holder and the robot unit is changed by the connection unit.

10. A computer readable recording medium having recorded thereon a program for executing the method of controlling the vehicle washing apparatus of claim 1.

11. A vehicle washing apparatus comprising:
a vehicle wash control device including a data collection unit configured to acquire an image of the vehicle, which is positioned in a vehicle wash region, from at least a camera, a communication unit configured to communicate with a smart device or an external vehicle information server, and a vehicle wash controller configured to determine information on an outer appearance of the vehicle based on information acquired from at least one of the data collection unit and the communication unit and to determine a moving path for washing the vehicle based on the determined information of the outer appearance;
a robot unit controlled by the vehicle wash controller and including at least one vehicle washing device; and
a moving unit controlled by the vehicle wash controller and configured to move or fix a position of the robot unit within the vehicle wash region,
wherein the moving path includes at least one of an autonomous moving path of the robot unit or a guided moving path of the robot unit through the moving unit.

12. The vehicle washing apparatus of claim 11, wherein the vehicle washing device includes at least one of a roller, at least one solution nozzle, and an air nozzle.

13. The vehicle washing apparatus of claim 12, further comprising a fluid management unit configured to supply a solution corresponding to the at least one solution nozzle and to supply air to the air nozzle,
wherein the solution includes at least water, detergent, or wax.

14. The vehicle washing apparatus of claim 11, wherein the robot unit includes a plurality of legs for performing autonomous movement.

15. The vehicle washing apparatus of claim 14, wherein an electromagnet for selectively generating magnetism is disposed at an end of each of the plurality of legs.

16. The vehicle washing apparatus of claim 11, wherein the vehicle wash control device transmits the image to the external vehicle information server, makes a request for data information related to the outer appearance of the vehicle, and receives the data information from the external vehicle information server, or receives the data information from the smart device, through the communication unit.

17. The vehicle washing apparatus of claim 16, wherein the vehicle wash control device determines the information on the outer appearance in consideration of an additional accessory of the vehicle together with the data information.

18. The vehicle washing apparatus of claim 11, wherein the moving unit is moved along two axes that cross each other above the vehicle and includes a robot holder connected to the robot unit through a connection unit.

19. The vehicle washing apparatus of claim 18, wherein a vertical distance between the robot holder and the robot unit is changed by the connection unit.
